(19) United States
(12) Patent Application Publication
(10) Pub. No.: US 2014/0010188 A1
(43) Pub. Date: Jan. 9, 2014

(54) MULTIPLE APERIODIC CHANNEL STATE INFORMATION TRANSMISSION ON PUSCH

(71) Applicants: Shupeng Li, Iselin, NJ (US); David Huo, Iselin, NJ (US)

(72) Inventors: Shupeng Li, Iselin, NJ (US); David Huo, Iselin, NJ (US)

(73) Assignee: ZTE (USA) INC, Richardson, TX (US)

(21) Appl. No.: 14/000,921

(22) PCT Filed: Feb. 23, 2012
(86) PCT No.: PCT/US12/26327

§ 371 Date: Sep. 26, 2013

Related U.S. Application Data
(60) Provisional application No. 61/445,951, filed on Feb. 23, 2011.
(60) Provisional application No. 61/445,951, filed on Feb. 23, 2011.

(51) Int. Cl. H04L 5/00

(52) U.S. Cl. CPC H04L 5/0057
USPC 370/329

(57) ABSTRACT

A method of transmitting a plurality of channel state information reports on a physical uplink shared channel includes separately coding each of the plurality of channel state information reports on the physical uplink shared channel. Each of the channel state information reports may be coded using tail-biting convolutional coding.

### FIELD OF THE INVENTION

The field of the present invention relates to wireless communication and more specifically, uplink control information in a Long Term Evolution Advanced system.

### BACKGROUND

Wireless cellular communication networks incorporate user equipment (“UE”) and a number of eNodeBs. An eNodeB is generally a fixed station, and may also be called a base transceiver system (“BTS”), an access point (“AP”), a base station (“BS”), or some other equivalent terminology. For efficient communication, UE reports channel state information to an eNodeB. UE, which is also commonly referred to as a terminal or a mobile station, may be a fixed or mobile device and may be a wireless device, a cellular phone, a personal digital assistant (“PDA”), and/or a wireless modem card, among other things. The UE generally reports the channel state information to the base station periodically or aperiodically. Channel state information (“CSI”) may include a channel quality indicator (“CQI”) and a precoding matrix index (“PMI”).

One way the UE can transmit channel state information reports to the base station is through a physical uplink shared channel (“PUSCH”). To improve the reliability of the transmission of the channel state information reports, these reports are coded onto a PUSCH for transmission. Accordingly, an improved method and system for transmitting aperiodic CSI reports through a PUSCH is desired.

### SUMMARY OF THE INVENTION

The present invention is directed towards systems and methods for transmitting a plurality of aperiodic CSI reports.

In a first aspect of the present invention, each of the plurality of CSI reports are coded separately for transmission on the physical uplink shared channel. Each of the channel state information reports may be coded using tail-biting convolutional coding.

In a second aspect of the present invention, the plurality of CSI reports are jointly coded for transmission on the physical uplink shared channel. The CSI reports may be coded using turbo coding if the payload size of the reports is smaller than a predetermined size. Alternatively, if the payload size of the reports is greater than a predetermined size, the CSI reports may be coded using tail-biting convolution coding.

Additional aspects and advantages of the improvements will appear from the description of the preferred embodiment.

### BRIEF DESCRIPTION OF THE DRAWINGS

Embodiments of the present invention are illustrated by way of the accompanying drawings, in which:

FIG. 1 illustrates sample block error rate curves for transmissions having different payload sizes using a 0.1 code rate;

FIG. 2 illustrates sample block error rate curves for transmissions having different payload sizes using a 0.5 code rate; and

FIG. 3 illustrates sample block error rate curves for transmissions having different payload sizes using a 0.9 code rate.

### DETAILED DESCRIPTION OF THE PREFERRED EMBODIMENTS

There are several options for encoding multiple aperiodic CQI/PMI reports on a PUSCH. In one option (“option A”), each aperiodic CQI/PMI report may be coded separately and concatenated with a certain order (e.g., based on a component carrier index of the control channel of which the CQI/PMI report corresponds). In another option (“option B”), the multiple aperiodic CQI/PMI reports may be jointly coded.

The preferred coding scheme for transmitting these reports on the PUSCH is based on the chosen option. For example, if option A is chosen, tail biting convolution coding (“TBCC”), as defined in Release 8 of the 3rd Generation Partnership Project (3GPP), should be reused for coding each aperiodic CQI/PMI report. This choice is made mainly because the maximum payload of an aperiodic CQI/PMI report is approximately 60 bits, which is within the optimal range of TBCC.

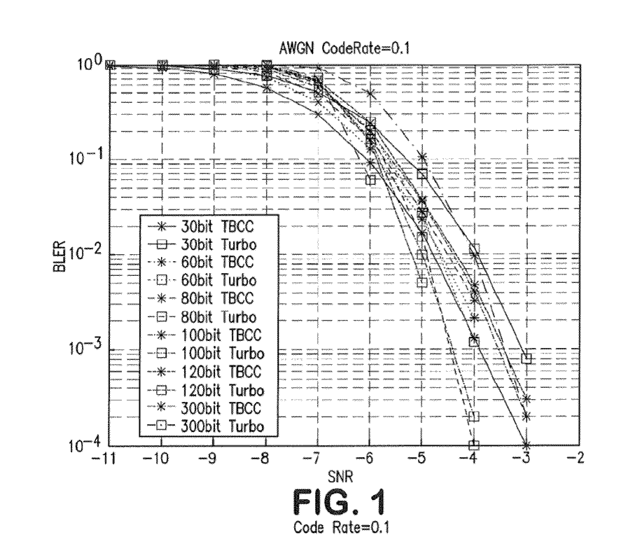

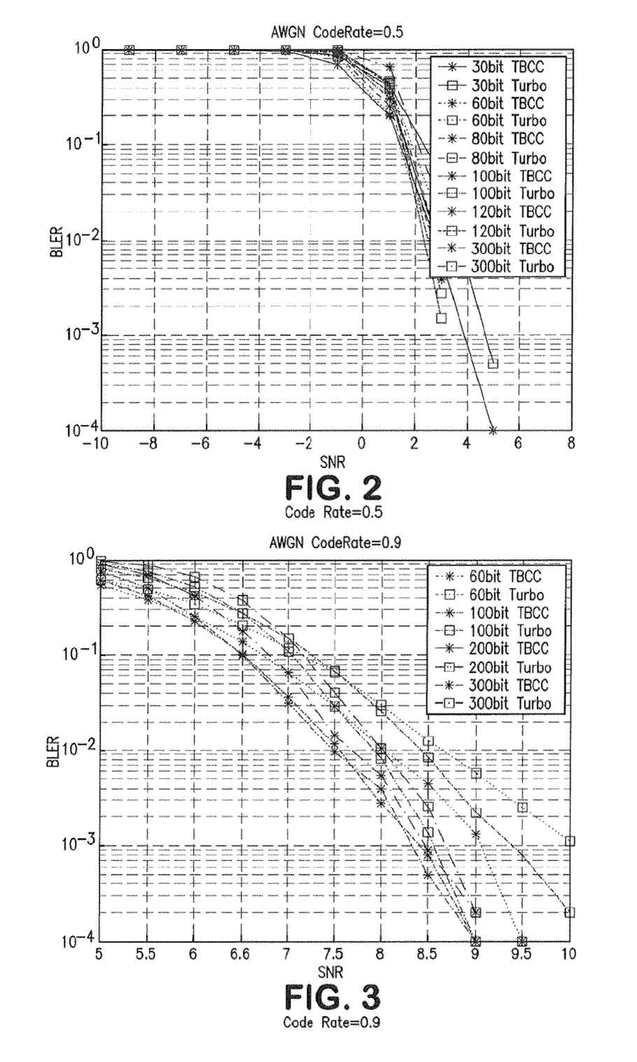

In option A, when decoding errors occur in some bits of some of the aperiodic CQI/PMI reports, only the aperiodic CQI/PMI reports where the error bits reside will be affected, while other aperiodic CQI/PMI reports still can be received correctly. An advantage of option B, however, is that an increased coding gain may be realized. For example, as can be seen in Tables 1-6 and FIGS. 1-3, option B (incorporating a turbo coding scheme) begins to have coding gain over TBCC when a payload, (or bit size) of the aperiodic CQI/PMI report, is larger than about 100.

TABLE 1
CodeRate = 0.1 BLER = 10%

| | |
|---|---|
| Code | TC |

| Bit Number | TBCC | TC | Gain |
|---|---|---|---|
| 30 | −6.1 | −5.3 | −0.7 |
| 60 | −5.85 | −5.65 | −0.2 |
| 80 | −5.73 | −5.75 | 0 |
| 100 | −5.6 | −5.85 | 0.2 |
| 120 | −5.5 | −5.88 | 0.38 |
| 300 | −5 | −6.2 | 0.8 |

TABLE 2
CodeRate = 0.1 BLER = 1%

| | |
|---|---|
| Code | TC |

| Bit Number | TBCC | TC | Gain |
|---|---|---|---|
| 30 | −4.8 | −3.95 | −0.75 |
| 60 | −4.65 | −4.7 | 0.05 |
| 80 | −4.5 | −4.9 | 0.4 |
| 100 | −4.4 | −5 | 0.6 |
| 120 | −4.35 | −5.2 | 0.76 |
| 300 | / | / | |

TABLE 3
CodeRate = 0.5 BLER = 10%

| | |
|---|---|
| Code | TC |

| Bit Number | TBCC | TC | Gain |
|---|---|---|---|
| 30 | 1.4 | 2.3 | −0.9 |
| 60 | 1.35 | 1.85 | −0.5 |
| 80 | 1.5 | 1.75 | −0.25 |
| 100 | 1.71 | 1.58 | 0.13 |
| 120 | 1.75 | 1.5 | 0.25 |
| 300 | 2.1 | / | |

TABLE 4
CodeRate = 0.5 BLER = 1%

| | |
|---|---|
| Code | TC |

| Bit Number | TBCC | TC | Gain |
|---|---|---|---|
| 30 | 2.71 | 3.7 | −0.99 |
| 60 | 2.53 | / | / |
| 80 | 2.65 | 2.85 | −0.2 |
| 100 | 2.49 | 2.84 | −0.35 |
| 120 | 2.8 | 2.35 | 0.45 |
| 300 | / | / | |

TABLE 5
CodeRate = 0.9 BLER = 10%

| | |
|---|---|
| Code | TC |

| Bit Number | TBCC | TC | Gain |
|---|---|---|---|
| 30 | | | |
| 60 | 6.75 | 7.15 | −0.4 |
| 80 | 6.51 | 7.25 | −0.74 |
| 100 | 6.5 | 7.05 | −0.5 |
| 120 | 6.8 | 7.13 | −0.33 |
| 300 | 6.75 | 7.15 | −0.4 |

TABLE 6
CodeRate = 0.9 BLER = 1%

| | |
|---|---|
| Code | TC |

| Bit Number | TBCC | TC | Gain |
|---|---|---|---|
| 30 | | | |
| 60 | 8 | 8.62 | −0.62 |
| 80 | 7.58 | 8.4 | −0.82 |
| 100 | 7.5 | 7.9 | −0.4 |
| 120 | 7.7 | 8.1 | −0.4 |
| 300 | 8 | 8.62 | −0.62 |

Unlike option A, selecting a code scheme for option B is more involved. For example, because option B entails joint coding for multiple aperiodic CQI/PMI reports, the payload size is increased significantly. Because of this payload size increase, a turbo coding scheme can be advantageous because turbo coding may result in better performance than TBCC when dealing with a larger payload size. On the other hand, there may be a longer decoding delay with turbo coding than with TBCC due to the complexity of turbo coding. Therefore, performance, decoding complexity, and decoding delay should be taken into account when selecting the coding scheme.

If option A is chosen, a resource element number for the CSI can either be: (1) calculated separately from the result of each separate coding output (i.e. the total number of resource elements is the summation of the number of each separate coding output), or (2) calculated jointly from the result of the total coded symbol. In the latter case, the resource element number can be calculated based on the total number of joint coding outputs.

In certain aspects of the present invention, one or more of the elements provided may take the form of computing devices. A “computing device”, as used herein, refers to a general purpose computing device that includes a processor. A processor generally includes a Central Processing Unit (“CPU”), such as a microprocessor. A CPU generally includes an arithmetic logic unit (“ALU”), which performs arithmetic and logical operations, and a control unit, which extracts instructions (e.g., code) from a computer readable medium, such as a memory, and decodes and executes them, calling on the ALU when necessary. “Memory”, as used herein, generally refers to one or more devices or media capable of storing data, such as in the form of chips or drives. Memory may take the form of one or more random-access memory (“RAM”), read-only memory (“ROM”), programmable read-only memory (“PROM”), erasable programmable read-only memory (“EPROM”), or electrically erasable programmable read-only memory (“EEPROM”) chips, by way of further non-limiting example only. Memory may take the form of one or more solid-state, optical or magnetic-based drives, by way of further non-limiting example only. Memory may be internal or external to an integrated unit including the processor. Memory may be internal or external to a computing device. Memory may store a computer program, e.g., code or a sequence of instructions being operable by the processor. In certain aspects of the present invention, one or more of the elements provided may take the form of code being executed using one or more computing devices, such as in the form of computer device executable programs or applications being stored in memory.

While embodiments of this invention have been shown and described, it will be apparent to those skilled in the art that many more modifications are possible without departing from the inventive concepts herein. The invention, therefore, is not to be restricted except in the spirit of the following claims.

1. A method of transmitting a plurality of channel state information reports on a physical uplink shared channel, the method comprising:
separately coding each of the plurality of channel state information reports on the physical uplink shared channel using tail-biting convolutional coding.

2. The method of claim 1, further comprising:
calculating a resource element number associated with the each of the plurality of separately coded channel state information reports to generate a plurality of resource element numbers; and
summing the resource element numbers associated with the each of the plurality of separately coded channel state information reports.

3. The method of claim 1, further comprising:
summing the plurality of separately coded channel state information reports to general a total coded symbol; and
calculating a resource element number based on the total coded symbol.

4. A method of transmitting a plurality of channel state information reports on a physical uplink shared channel, the method comprising:
jointly coding the plurality of channel state information reports on the physical uplink shared channel using one of a first coding scheme and a second coding scheme, wherein the first coding scheme is used when a payload size of the channel state information reports is smaller than a predetermined size.

5. The method of claim 4, further comprising:
calculating a resource element number based on the jointly coded symbol,

6. The method of claim 4, wherein the first coding scheme comprises turbo coding.

7. The method of claim 4, wherein the second coding scheme comprises tail-biting convolutional coding.

8. A computer program product for transmitting a plurality of channel state information reports on a physical uplink shared channel, the computer program-product residing on a computer-readable medium and comprising computer-readable instructions configured to cause a computer to:
separately code each of the plurality of channel state information reports on the physical uplink shared channel using tail-biting convolutional coding.

9. The product of claim 9, wherein the computer-readable instructions are further configured to cause the computer to:
calculate a resource element number associated with the each of the plurality of separately coded channel state information reports to generate a plurality of resource element numbers; and
sum the resource element numbers associated with the each of the plurality of separately coded channel state information reports.

10. The product of claim 9, wherein the computer-readable instructions are further configured to cause the computer to:
sum the each of the plurality of separately coded channel state information reports to general a total coded symbol; and
calculate a resource element number based on the total coded symbol.

11. A computer program product for transmitting a plurality of channel state information reports on a physical uplink shared channel, the computer program-product residing on a computer-readable medium and comprising computer-readable instructions configured to cause a computer to:
jointly code the plurality of channel state information reports on the physical uplink shared channel using one of a first coding scheme and a second coding scheme, wherein the first coding scheme is used when a payload size of the channel state information reports is smaller than a predetermined size.

12. The product of claim 11, further comprising computer-readable instructions configured to cause the computer to:
calculate a resource element number based on the jointly coded symbol.

13. The product of claim 11, wherein the first coding scheme comprises turbo coding.

14. The product of claim 11, wherein the second coding scheme comprises tail-biting convolutional coding.
